(19) United States
(12) Patent Application Publication
(10) Pub. No.: US 2020/0008346 A1
(43) Pub. Date: Jan. 9, 2020

(54) Spreader Cover Having Modular Hard Covers Movable by Linkages or Slide Mechanisms and Including Extended Handles

(71) Applicant: THE TORO COMPANY, Bloomington, MN (US)

(72) Inventors: Joe Goudreau, Norway, MI (US); David G. Surridge, Hickory, NC (US); Stephen David Veihl, Iron Mountain, MI (US)

(21) Appl. No.: 16/490,648

(22) PCT Filed: Mar. 14, 2018
(86) PCT No.: PCT/US18/22352

§ 371 Date: Sep. 3, 2019

Related U.S. Application Data
(60) Provisional application No. 62/471,282, filed on Mar. 14, 2017.

(51) Int. Cl. A01C 15/00; B65D 90/00; B60N 3/02

(52) U.S. Cl. CPC A01C 15/006; E01C 19/203; B60N 3/023; B65D 90/00

(57) ABSTRACT

A spreader cover for a hopper of a spreader includes one or more modular hard covers that may be arranged to fully cover the hopper. In an embodiment, the spreader cover also includes a plurality of linkages, each linkage connected to one of the one or more modular hard covers. In another embodiment, the spreader cover includes a plurality of slide mechanisms, each slide mechanism connected to one of the one or more modular hard covers. The spreader cover may optionally include an extended handle assembly to facilitate opening the spreader cover while an operator is standing on the ground. The extended handle assembly may have an opening position and a closing position in which an external handle is unable to rotate, and a rotating position in which the external handle may be rotated and secured to the side of a vehicle.

### CROSS-REFERENCE TO RELATED APPLICATIONS

This application claims the benefit of the filing date of U.S. Provisional Appl. No. 62/471,282, filed Mar. 14, 2017, which is hereby incorporated by reference.

### FIELD OF THE DISCLOSURE

This application relates generally to spreaders for de-icing materials, and more specifically, to a spreader cover having modular hard covers for a hopper, each modular hard cover secured to a grate on the hopper by either a linkage or a sliding mechanism, and optionally including an extended handle.

### BACKGROUND

Spreaders for de-icing materials, such as salt, are critical for winter snow and ice removal. Spreaders typically include a hopper from which the de-icing material is distributed. The top of the hopper should ideally be covered in order to protect and preserve the de-icing material, as well as to prevent the de-icing material from spilling into the vehicle box upon which the spreader is placed. However, the cover must still allow the hopper to be re-filled with de-icing material as needed. Some known covers are cumbersome to remove and require an operator to climb onto the vehicle upon which the hopper is mounted, often in slippery winter conditions, in order to open the cover.

### SUMMARY

The present disclosure is directed to a spreader cover for a hopper of a spreader. The spreader cover is designed to be opened by an operator while the operator is standing on the ground. The spreader cover of the present disclosure requires very little effort to open and close. The spreader cover protects the de-icing material from the elements, and protects the vehicle bed and operator from spills of the de-icing material.

The spreader cover includes one or more modular hard covers. Each of the one or more modular hard covers may comprise a back side, an opening side, and two lateral sides. The back side is opposite the opening side. The back sides of two modular hard covers of the one or more modular hard covers may be adjacent to one another so that opening sides are provided on opposite sides of the hopper. This makes it possible for an operator to open the hopper from either side, without having to climb up on a truck tire or running board to reach the covers. The modular hard covers may be connected to one another. For example, if a lateral side of a first modular hard cover of the one or more modular hard covers is adjacent a lateral side of a second modular hard cover of the one or more modular hard covers, the adjacent lateral sides may be fastened to one another. In some cases, the adjacent lateral sides may have ridges provided for such fastening. An integral handle may be provided on the opening side of each modular hard cover to facilitate opening the modular hard cover.

The spreader may include a hopper having a width and a length for holding a de-icing material, a grate covering the hopper, a motorized spinner assembly for expelling the de-icing material from the hopper during spreading of the de-icing material, and a controller for controlling the spreading of the de-icing material. The modular hard covers may each have a width and a length, and they may be arranged such that a combined width of the one or more modular hard covers is equal to the width of the hopper and a combined length of the one or more modular hard covers is equal to the length of the hopper. Some modular hard covers may have edges modified to better fit on the hopper, such as by having a shape identical to the shape of the hopper. Some modular hard covers may include a detent configured to align with an edge of the hopper when the modular hard cover is in a closed position, thereby giving a user tactile and visual feedback to determine whether the modular hard cover is fully closed. In spreaders using slide mechanisms, the detent also keeps a slide plate of the slide mechanism from contacting the hopper, thereby preventing damage to the hopper.

Each of the modular hard covers may be opened using one of two opening mechanisms: a linkage or a slide mechanism. Each linkage or each slide mechanism is connected to one of the one or more modular hard covers. These mechanisms allow the modular hard covers to be opened with minimal effort.

Turning first to the linkages, each linkage includes a linkage mounting bracket securable to a grate provided on the hopper. In alternate embodiments not herein depicted, the linkage mounting bracket may be connected directly to the hopper. A first link connects the linkage mounting bracket to the modular hard cover to which the linkage is connected. Likewise, a second link connects the linkage mounting bracket to the modular hard cover to which the linkage is connected. A retaining pin is configured to secure the first link and the second link to the linkage mounting bracket.

The linkage mounting bracket may include a base having a first side having a first pin hole, a second side have a second pin hole aligned with the first pin hole, and a bottom plate. The bottom plate may have a width and a length that exceeds a width and a length of a grate hole in the grate of the hopper, thereby allowing the bottom plate to sit upon the grate without falling through the grate. The linkage mounting bracket may include at least one catch plate configured for attachment below the bottom plate and the grate when the linkage mounting bracket is secured to the grate. The catch plate may have a width that is less that the width of the grate hole so that it can be inserted through the hole when the linkage mounting bracket is placed upon the grate. The linkage mounting bracket may further include a top having a top plate, a first inclined side, and a second inclined side. The top may be secured on the first side and the second side of the base. The retaining pin may be configured for insertion in the first pin hole and the second pin hole. Once inserted, the retaining pin may be configured to secure the first link between the first side of the base and the first inclined side of the top and the second link between the second side of the base and the second inclined side of the top.

The first link of the linkage may be in tension, and the second link of the linkage may be in compression, when the linkage mounting bracket is connected to the hopper. In some arrangements, the first side and the second side of the base of the linkage mounting bracket may be parallel to the back side and the opening side of the modular hard cover when the linkage mounting bracket is secured to the grate. The first side of the base of the linkage mounting bracket may be closer to the back side of the modular hard cover than the second side of the base of the linkage mounting bracket. The first link may be identical in size and shape to the second link such that, due to locations at which the first link and the second link connect to the linkage mounting bracket, the first link connects closer to the back side of the modular hard cover than the second link.

Each of the one or more modular covers has a bottom that may be provided with a ridge. The ridge may have a first port for connection to the first link and a second port for connection to the second link. In some arrangements, the ridge is perpendicular to the back side and the opening side of each modular hard cover. A first recessed groove and a second recessed groove in the bottom of each modular cover may be provided. The first and second recessed grooves may run parallel to the back side and the opening side of the modular cover and may be provided adjacent the first port and the second port, respectively, to allow the first link to connect to the first port and the second link to connect to the second port.

An alternate manner of connecting the spreader cover to the hopper is using slide mechanisms. Turning now to the slide mechanisms, each slide mechanism may include a slide plate connected to one of one or more modular hard covers, the slide plate including a slide pathway. Each slide mechanism may further include a slide mounting bracket connected to the hopper, the slide mounting bracket including an upper bushing and a lower bushing. The slide mounting bracket may be connected to the hopper by being securable to a grate provided on the hopper. In other embodiments not herein depicted, the slide mounting bracket may be connected directly to the hopper. A wheel may be mounted on a pin, such as a clevis pin, in the upper bushing, and a roller may be mounted on a roller axle in the lower bushing. Each of the plurality of slide mechanisms is configured such that the wheel is slidable in the slide pathway of the slide plate while the roller is located below the slide plate. The roller may include, or be made entirely of, a low friction polymer in order to facilitate sliding of the slide plate against the slide mounting bracket.

The slide plate has sides lateral to the slide pathway, and the wheel may have a groove between inner surfaces of the wheel. The inner surfaces of the wheel may be configured to engage the sides of the slide plate. The slide mounting bracket may include a securement plate having one or more fastening apertures. The securement plate has a width and a length that exceeds a width and a length of a grate hole in the grate of the hopper so that can be placed atop the grate. The securement plate may also have a lower plate configured for attachment below the securement plate and the grate when the slide mounting bracket is secured to the grate. The slide plate may include a first slide aperture and a second side aperture in the sides lateral to the slide pathway. Each of the one or more modular hard covers has a bottom, and a ridge may be provided on the bottom of each of the plurality of hard covers. The ridge may be connected to the first side aperture and the second side aperture in the sides lateral to the slide pathway.

The slide plate may include an upper attachment plate that may be connected to the bottom of one of the one or more modular hard covers. The slide plate may also include an opening end attachment plate, the opening end attachment plate connected to one of the modular hard covers near the opening side of the modular hard cover.

Installation and removal of a modular hard cover using the slide mechanism is straightforward and does not require any tools. The modular hard cover being installed or removed is positioned on its back side. The wheel of the slide mounting bracket is inserted into the slide pathway of the slide plate, and the pin holding the wheel in place is inserted. The pin may, for example, be a clevis pin.

Another feature that the spreader cover may include is an extended handle assembly. The extended handle assembly extends the reach of a controller to facilitate opening and closing the spreader cover. Even shorter spreader operators can easily open the spreader cover using the extended handle assembly because the extended handle assembly extends the reach of an operator by up to 18 inches. The extended handle assembly has an opening position and closing position, and for both the opening and closing positions the extended handle projects outwardly from the side of the vehicle in which the spreader is mounted. The extended handle assembly also has a rotating position in which an extended handle of the extended handle assembly can be rotated inward toward the side of the vehicle and closer to the hopper. The extended handle may be secured to the side of the vehicle using a bracket or other connection means when in the rotating position. The extended handle is secured away from the hopper when in an opening or closing position so that rotation is not possible. The extended handle assembly prevents the extended handle from rotating when it is in the opening or closing position so that, if an operator forgets or chooses not to rotate and secure the extended handle in a bracket on the vehicle, the extended handle will not inadvertently rotate from the opening or closing position and slam into the outer panel of a truck bed on the vehicle body (for example, when the hopper is being refilled with salt or sand, which may fall and exert a downward force on the extended handle).

The extended handle assembly may include a handle bracket connected to one of the one or more modular hard covers and an extended handle connected to the handle bracket. The handle bracket includes a multi-positioning recess and a handle aperture within the multi-position recess. The extended handle includes an extension plate and a grab bar connected to the extension plate, the extension plate securable by a fastener to the handle aperture of the handle bracket. The multi-position recess of the handle bracket has a recess longitudinal axis and a closing portion, rotating portion, and opening portion along the longitudinal axis. The extension plate of the extended handle may include a raised portion through which the fastener is secured. The extended handle may be positioned in an opening position when any of the raised portion is in the opening portion of the multi-position recess, a rotating position when all of the raised portion is in the rotating portion of the multi-position recess, and a closing position when any of the raised portion is in the closing portion of the multi-position recess. The opening portion and the closing portion of the multi-position recess are configured such that the extended handle is unable to rotate in the opening and in the closing position.

Specifically, the multi-position recess may have a recess length along the recess longitudinal axis, a closing width at the closing portion, a rotating width at the rotating portion, and an opening width at the opening portion. The raised portion of the extension plate of the extended handle has a raised portion length along a raised portion longitudinal axis that is less than the recess length and the rotating width but greater than the closing width and opening width. The result is that the raised portion is able to rotate in the rotating portion because its length is less than the recess length and the rotating width of the rotating portion. However, the raised portion is not able to rotate in the opening and closing positions because its length is greater than the closing width and opening width, and therefore does not have enough space to turn within the opening and closing portions.

The handle aperture within the multi-position recess has a handle aperture length along a handle aperture longitudinal axis. The fastener of the extension plate as a fastener length that is less than the handle aperture length. This arrangement allows the fastener of the extension plate to slide within the handle aperture along the handle aperture longitudinal axis, permitting the raised portion to move between the opening, rotating, and closing positions.

The handle bracket may further include a material egress hole within the multi-position recess. The material egress hole allows salt or sand or other debris caught within the recess to be removed so as to ensure proper functioning of the extended handle assembly. The extension plate may have a length of up to 18 inches so as to accommodate shorter operators. In the embodiments shown in the drawings, the extended handle assembly includes a first handle bracket and a second handle bracket, the first handle bracket secured to a first one of the one or more modular hard covers and the second handle bracket secured to a second one of the one or more modular hard covers. In the embodiments shown in the drawings, the handle extension includes a first extension plate and a second extension plate, the first extension plate secured to the first handle bracket and the second extension plate secured to the second handle bracket. However, the extended handle assembly may be configured to connect to only one or more than two modular hard covers, and the extended handle assembly may include only one or more than two handle brackets and extension plates.

### BRIEF DESCRIPTION OF THE DRAWINGS

FIG. 1 is front view of a spreader having a spreader cover using linkages of the present disclosure.

FIG. 2 is a top view of the spreader and the spreader cover of FIG. 1, the spreader cover having four modular hard covers each secured to a grate of a hopper of the spreader by a linkage.

FIG. 3 is an isometric view of the linkage shown in FIG. 2 connecting a modular hard cover to the grate of the hopper.

FIG. 4 is an exploded, isometric view of the linkage of the present disclosure.

FIG. 5 is a bottom view of the linkage of the present disclosure connected to the bottom of a modular hard cover of the present disclosure.

FIG. 6 is a bottom isometric view of two connected modular hard covers of the present disclosure.

FIG. 7 is a top view of the two connected modular hard covers of FIG. 6.

FIG. 8 is a bottom view of the two connected modular hard covers of FIGS. 6 and 7.

FIG. 9 is side view of the two connected modular hard covers of FIGS. 6-8.

FIG. 10 is a front view of the two connected modular hard covers of FIGS. 6-9.

FIG. 11 is a back view of the two connected modular hard covers of FIGS. 6-10.

FIG. 12 is an isometric view of a hopper and spreader cover using linkages of the present disclosure.

FIG. 13 is a top view of the hopper and spreader cover of FIG. 12, with the hard covers defining the spreader cover in a closed position.

FIG. 14 is a bottom view of the hopper and spreader cover of FIGS. 12 and 13.

FIG. 15 is a front view of the hopper and spreader cover of FIGS. 12-14.

FIG. 16 is a side view of the hopper and spreader cover of FIGS. 12-15.

FIG. 17 is a front view of a hopper and spreader cover using slide mechanisms and including extended handle assemblies of the present disclosure.

FIG. 18 is a top view of the hopper and spreader cover of FIG. 17.

FIG. 19 is an isometric view from the front left side of the hopper and spreader cover of FIGS. 17 and 18, showing the extended handle assembly in a rotating position.

FIG. 20 is a close-up view from the front left side of the extended handle assembly in a rotating position of FIG. 19.

FIG. 21 is an isometric view from the back right side of the hopper and spreader cover of FIGS. 17-20, showing the extended handle assembly in an opening position.

FIG. 22 is a close up view from the front right side of the extended handle assembly in an opening position of FIG. 21.

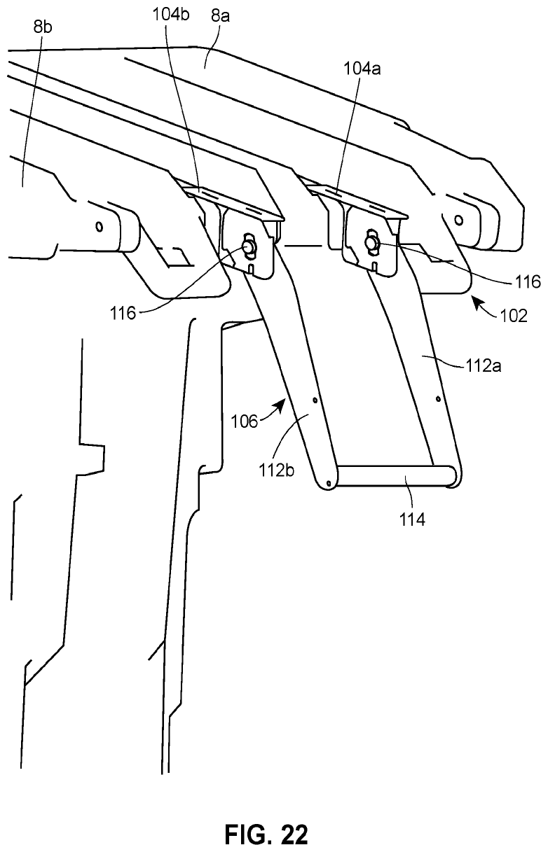

FIG. 23 is an isometric view of an extended handle of the present disclosure.

FIG. 24 is a side view of the extended handle of FIG. 23.

FIG. 25 is a side view of the handle bracket of the present disclosure.

FIG. 26 is an isometric view of the top of two connected modular hard covers, each modular hard cover including a handle bracket, of the present disclosure.

FIG. 27 is a side view of the two connected modular hard covers of FIG. 26.

FIG. 28 is a bottom view of the two connected modular hard covers of FIGS. 26 and 27.

FIG. 29 is an isometric view of the bottom of the two connected modular hard covers of FIGS. 26-28.

FIG. 30 is an isometric view of a slide plate of the present disclosure.

FIG. 31 is a side view of the slide plate of FIG. 30.

FIG. 32 is an isometric view of the slide mounting bracket of the present disclosure.

FIG. 33 is a front view of the slide mounting bracket of FIG. 32.

FIG. 34 is a top view of the slide mounting bracket of FIG. 32.

FIG. 35 is an isometric view of modular hard cover configured to be attached using a slide mechanism in an installation position.

### DETAILED DESCRIPTION OF THE DRAWINGS

Although the following text sets forth a detailed description of one or more exemplary embodiments of the invention, it should be understood that the legal scope of the invention is defined by the words of the claims set forth at the end of this patent. The following detailed description is to be construed as exemplary only and does not describe every possible embodiment of the invention, as describing every possible embodiment would be impractical, if not impossible. Numerous alternative embodiments could be implemented, using either current technology or technology developed after the filing date of this patent, and such alternative embodiments would still fall within the scope of the claims defining the invention.

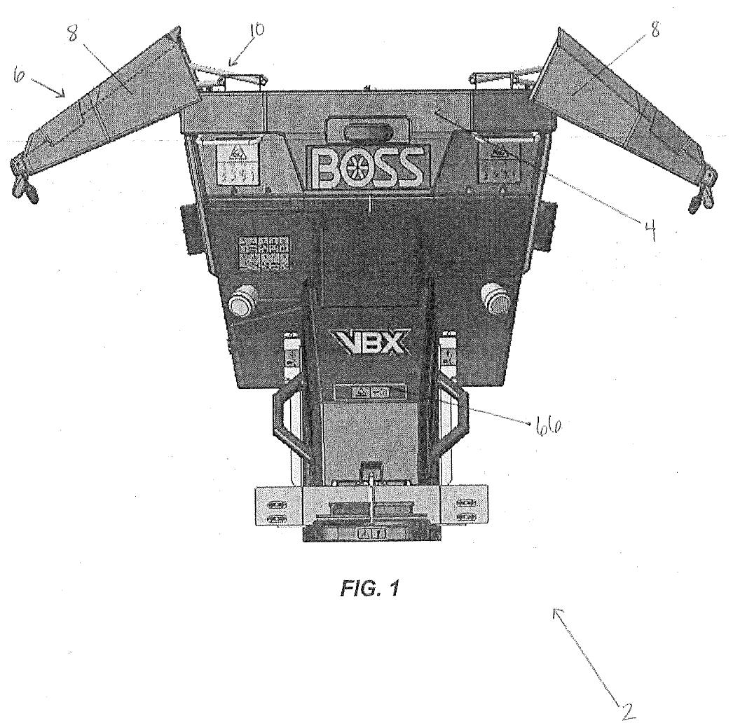

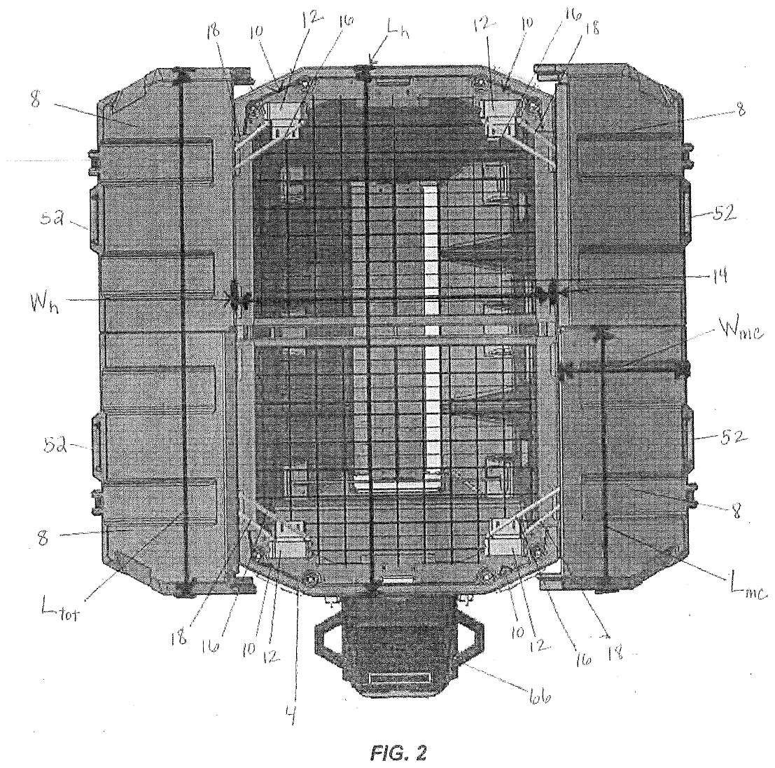

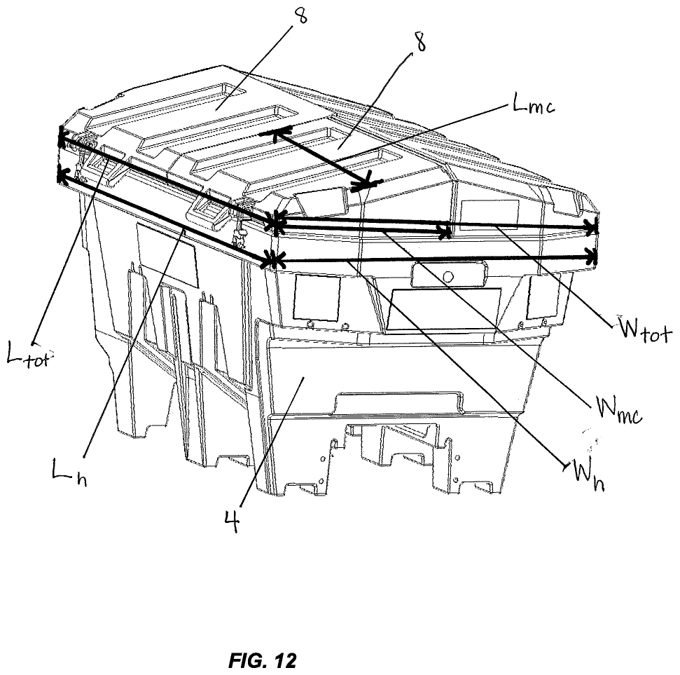

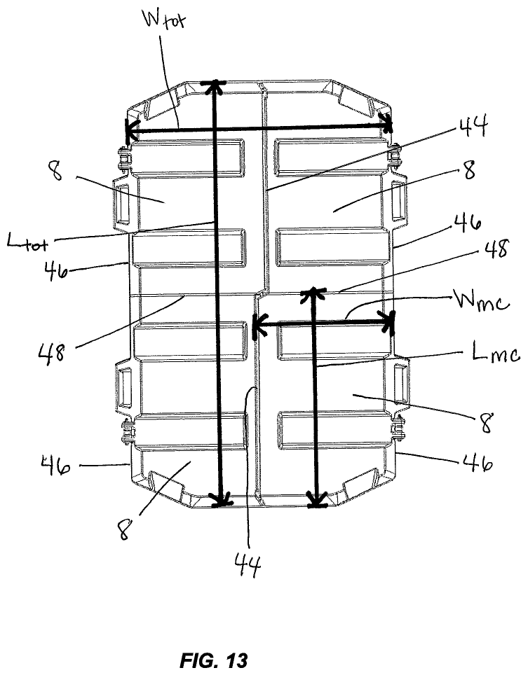

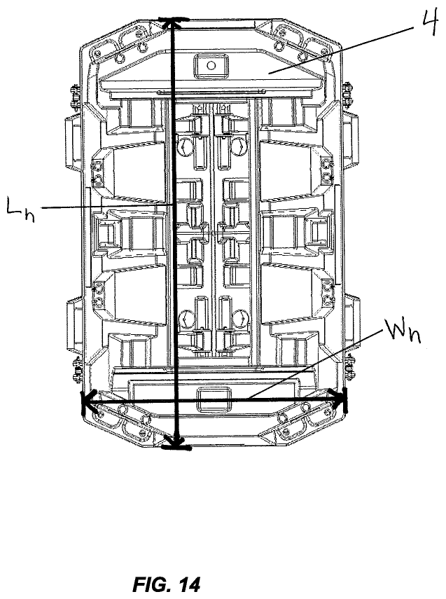

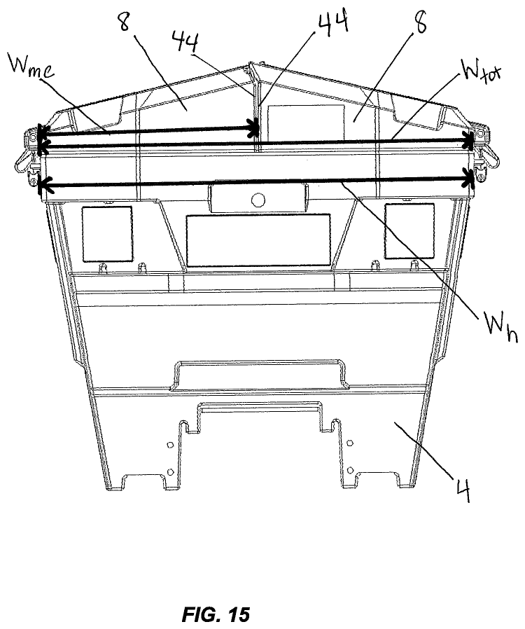

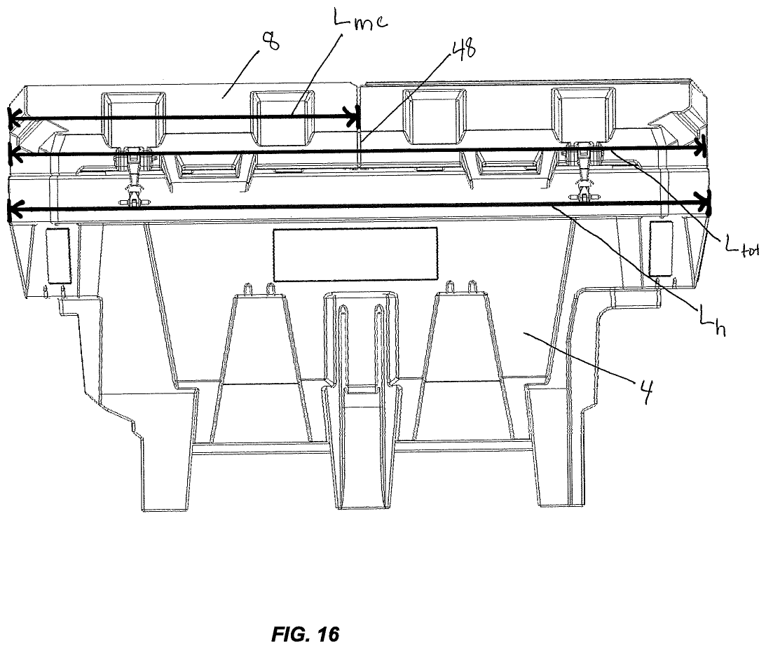

FIGS. 1 and 2 depict a spreader 2 having a spreader cover 6. The spreader 2 includes a hopper 4 for holding a de-icing material. As shown in FIG. 2, as well as FIGS. 12-16, the hopper 4 has a width Wₕ and a length Lₕ, and a grate 14 covers the hopper 4. As shown in FIGS. 1 and 2, the spreader 2 includes a motorized spinner assembly 66 for expelling the de-icing material from the hopper 4 during spreading of the de-icing material. The spreader also includes a controller (not pictured) for controlling the spreading of the de-icing material. The spreader cover 6 includes one or more modular hard covers 8. As shown in FIG. 2, as well as FIGS. 12-16, each modular hard cover 8 has a width W_{mc} and a length L_{mc}. The one or more modular hard covers 8 are arranged such that a combined total width Wₜₒₜ of the one or more modular hard covers 8 is equal to the width Wₕ of the hopper and a combined total length Lₜₒₜ is equal to the length Lₕ of the hopper. A plurality of linkages 10 are shown, each linkage 10 connected to one of the one or more modular hard covers 8.

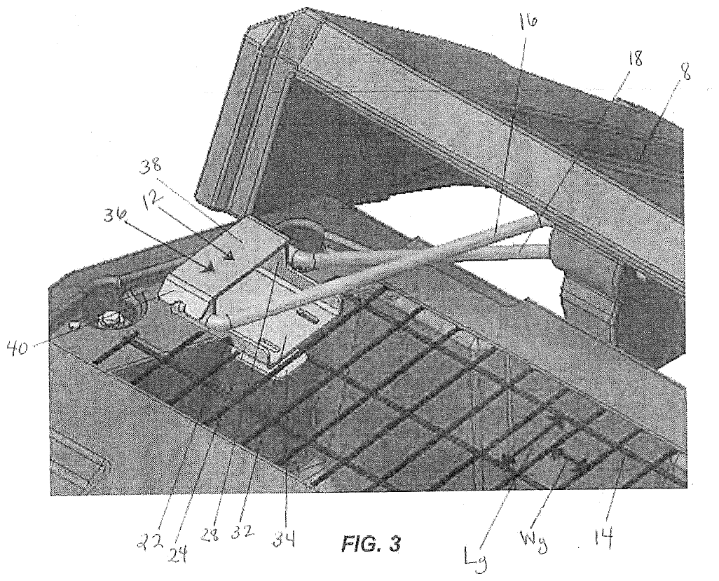

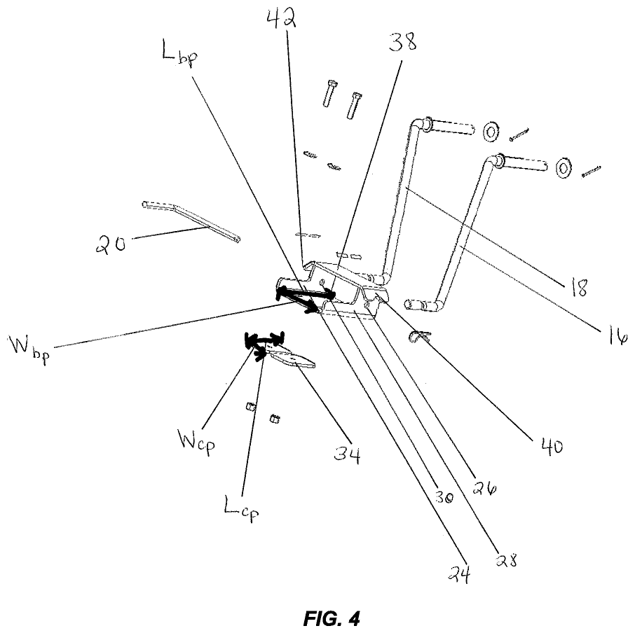

As shown in FIGS. 2 and 3, each linkage 10 includes a linkage mounting bracket 12 securable to the grate 14. A first link 16 and a second link 18 connect the linkage mounting bracket 12 to a modular hard cover 8. As shown in FIG. 4, a retaining pin 20 is configured to secure the first link 16 and the second link 18 to the linkage mounting bracket 12. The linkage mounting bracket 12 includes a base 22 having a first side 24 and a second side 28. A first pin hole 26 is provided in the first side 24, and a second pin hole 30 is provided in the second side 28. The first pin hole 26 is aligned with the second pin hole 26. The base 22 also has a bottom plate 32. The bottom plate has a width W_{bp} and a length L_{bp} (shown in FIG. 4) that exceeds a width W_{g} and a length L_{g} of a grate hole 70 in the grate 14 (shown in FIG. 3). The linkage mounting bracket 12 also includes two catch plates 34, each catch plate 34 having a width W, that is less than a width W_{g} of the grate hole 70. The linkage mounting bracket 12 includes a top 36 having a top plate 38, a first inclined side 40, and a second inclined side 42. The top 36 is secured on the first side 24 and the second side 28 of the base 22. The retaining pin 20 is configured for insertion in the first pin hole 26 and the second pin hole 30 in order to secure the first link 16 between the first side 24 of the base 22 and the first inclined side 40 of the top 36 and the second link 18 between the second side 28 of the base 22 and the second inclined side 42 of the top 36.

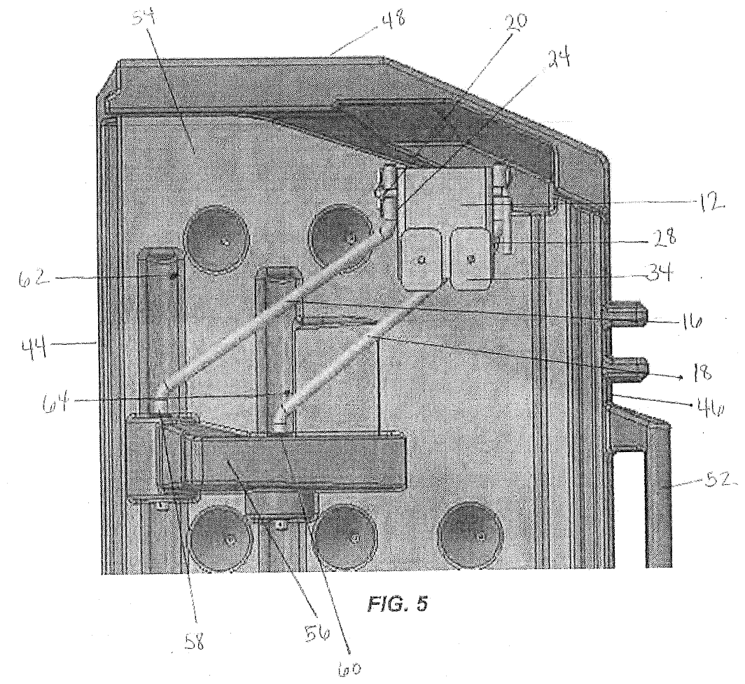

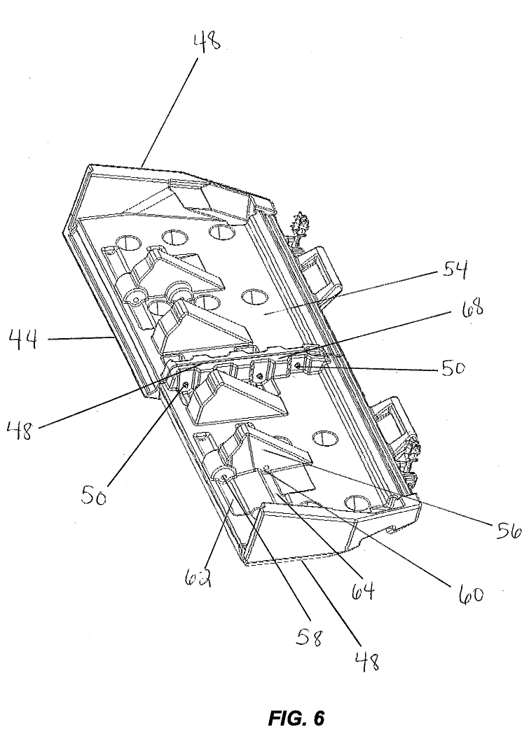

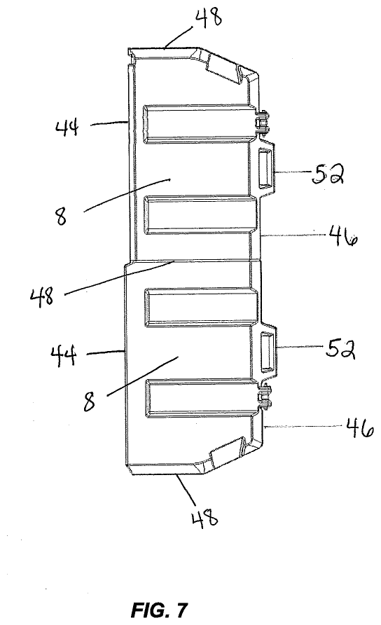

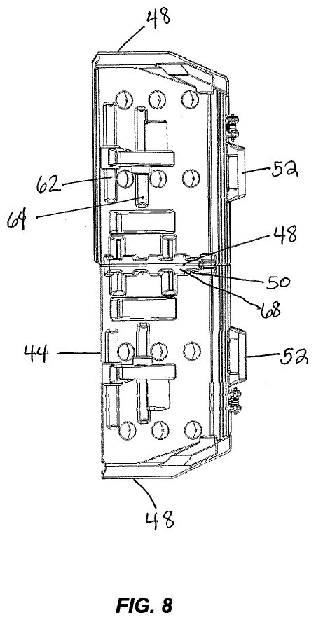

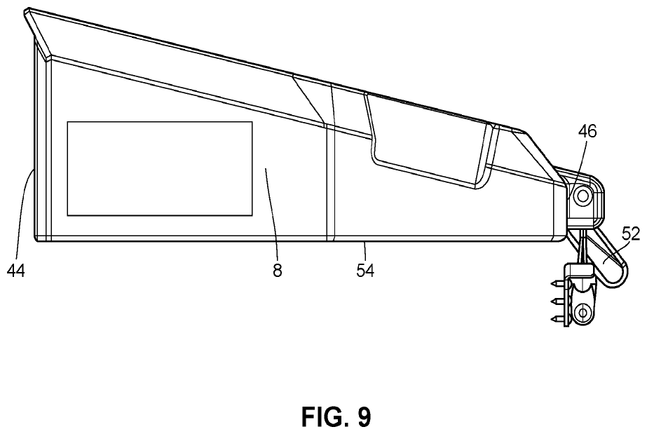

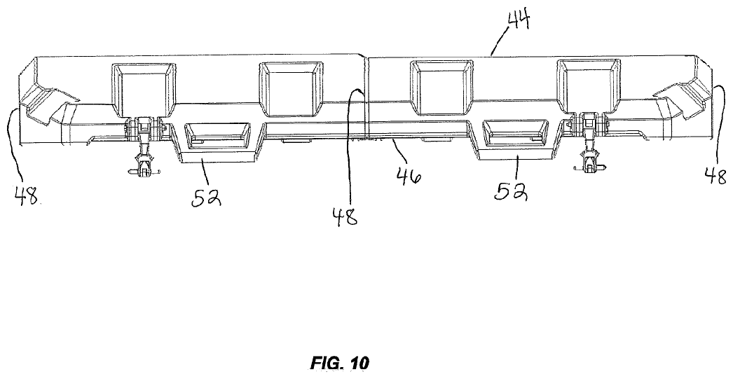

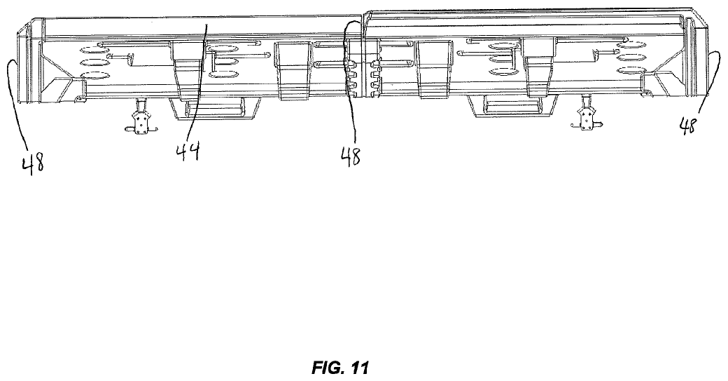

Turning to FIGS. 5 and 6, each of the one or more modular hard covers 8 comprises a back side 44, an opening side 46, and two lateral sides 48. The back side 44 is opposite the opening side 46. As shown in FIGS. 12, 13, and 15, the back sides 44 of two modular hard covers 8 are adjacent to one another so that opening sides 46 are provided on opposite sides of the hopper 4. Additionally, as shown in FIGS. 7-11, if a lateral side 48 of a first modular hard cover 8 is adjacent a lateral side 48 of a second modular hard cover 8, the adjacent lateral sides 48 are fastened to one another. FIG. 6 shows a plurality of fastening locations 50 where fasteners secure the adjacent lateral sides 48 to one another and fastening ridges 68 in which the fastening locations 50 are provided. The opening side 46 of each modular hard cover 8 includes an integral handle 52 to facilitate opening the modular hard cover 8.

The first link 16 is in tension when the linkage mounting bracket 12 is secured to the grate 14 of the hopper 4 of the spreader 2, while the second link 18 is in compression when the linkage mounting bracket 12 is secured to the grate 14 of the hopper 4 of the spreader 2. As shown in FIGS. 3 and 5, the first side 24 and the second side 28 of the base 22 of the linkage mounting bracket 12 are parallel to the back side 44 and the opening side 46 of the modular hard cover 12 when the linkage mounting bracket 12 is secured to the grate 14. The first side 24 of the base 22 of the linkage mounting bracket 12 is closer to the back side 44 of the modular hard cover 8 than the second side 28 of the base 22 of the linkage mounting bracket 12. As shown in FIG. 4, the first link 16 is identical in size and shape to the second link 18. Accordingly, due to the locations at which the first link 16 and the second link 18 connect to the linkage mounting bracket 12 (shown in FIGS. 3 and 5), the first link 16 connects closer to the back side 44 of the modular hard cover 8 than the second link 18 (shown in FIG. 5).

As shown in FIGS. 5 and 6, each of the modular hard covers 8 has a bottom 54. A ridge 56 is provided on the bottom 54 of each modular hard cover 8. The ridge 56 has a first port 58 for connection to the first link 16 and a second port 60 for connection to the second link 18. The ridge 56 is perpendicular to the back side 44 and the opening side 46 of the modular hard cover 8. A first recessed groove 62 and a second recessed groove 64 in the bottom 54 of each modular hard cover 48 run parallel to the back side 44 and the opening side 46 of the modular hard cover 8. The first recessed groove 62 is adjacent the first port 58 while the second recessed groove 64 is adjacent the second port 60.

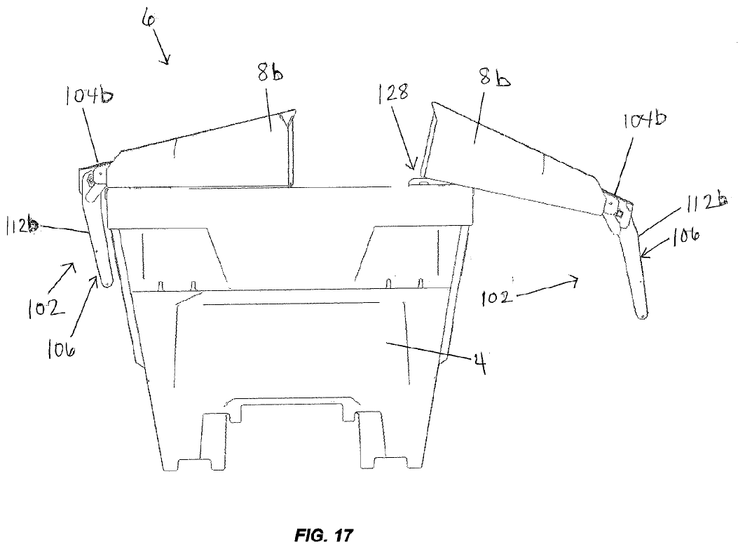

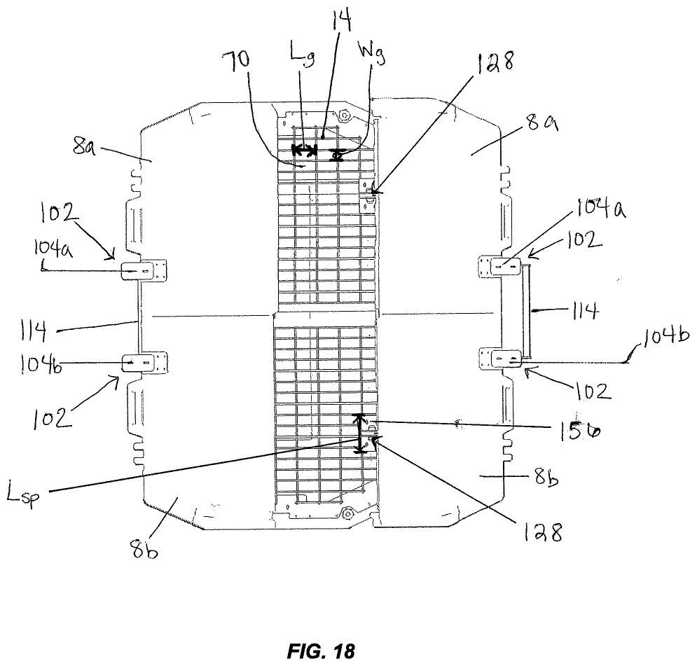

FIGS. 17, 18, 19, and 21 illustrate a spreader 2 on a hopper 4 having a spreader cover 6. As illustrated in FIG. 18, a grate 14 covers the hopper 4, and the grate 14 includes grate holes 70 having a width W_{g} and a length L_{g}. The spreader cover 6 includes one or more modular hard covers 8(a,b). A plurality of slide mechanisms 128 are shown, each slide mechanism 128 connected to one of the one or more modular hard covers 8.

The spreader cover 6 includes extended handle assemblies 102. Each extended handle assembly 102 includes a handle bracket 104 and an extended handle 106. Each extended handle 106 includes at least one extension plate 112 and a grab bar 114 connected to the extension plate. The extended handle assemblies 102 are configured to move between an opening position wherein the extended handle 106 is secured away from the hopper 4, a rotating position wherein the extended handle 106 may rotate to be secured closer to the hopper 4, and a closing position wherein the extended handle 106 is secured away from the hopper 4. The extended handle assemblies 102 are configured such that the extended handle 106 is unable to rotate in the opening position and the closing position. In FIGS. 17 and 18, the extended handle assemblies 102 illustrated on the left are in a rotating position, and the extended handle assemblies 102 illustrated on the right are in an opening position.

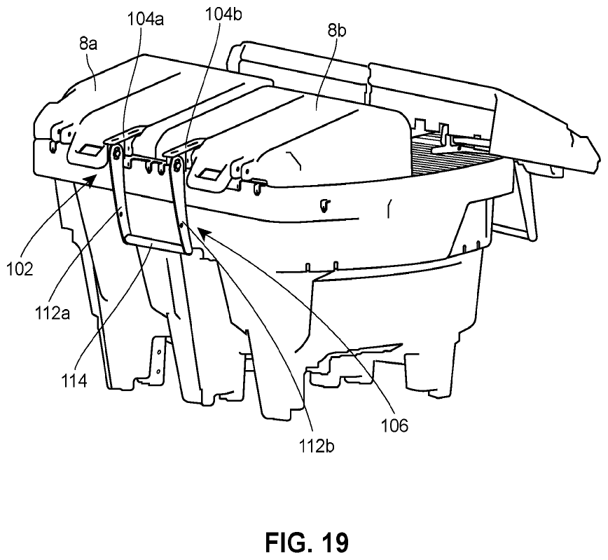

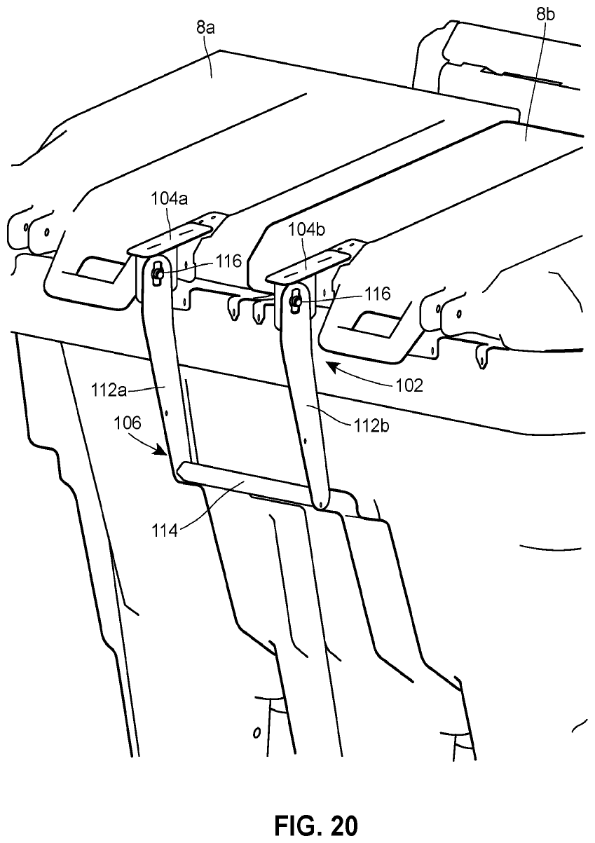

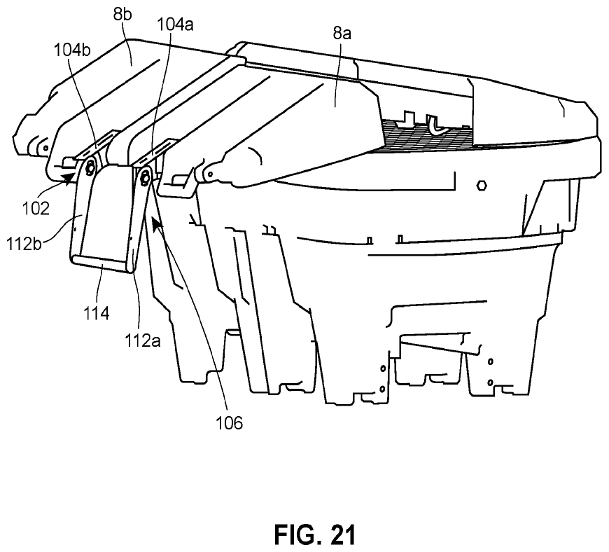

FIGS. 19 and 21 illustrate a close up of the extended handle assemblies 102 in a rotating position and an opening position, respectively. As best shown in FIGS. 19 and 20, each extended handle assembly 102 may include a first handle bracket 104a and a second handle bracket 104b, the first handle bracket 104a secured to a first one of the one or more modular hard covers 8a and the second handle bracket 104b secured to a second one of the one or more modular hard covers 8b. The handle extension 106 includes a first extension plate 112a and a second extension plate 112b, the first extension plate 112a secured to the first handle bracket 104a and the second extension plate 112b secured to the second handle bracket 104b. In other embodiments not shown herein, each extended handle assembly 102 may be connected to only one modular hard cover 8 or may be connected to more than two modular hard covers 8. In other embodiments not shown herein, each handle assembly 102 may include only one handle bracket 104 and handle extension plate 112 or may include more than two handle brackets 104 and handle extension plates 112.

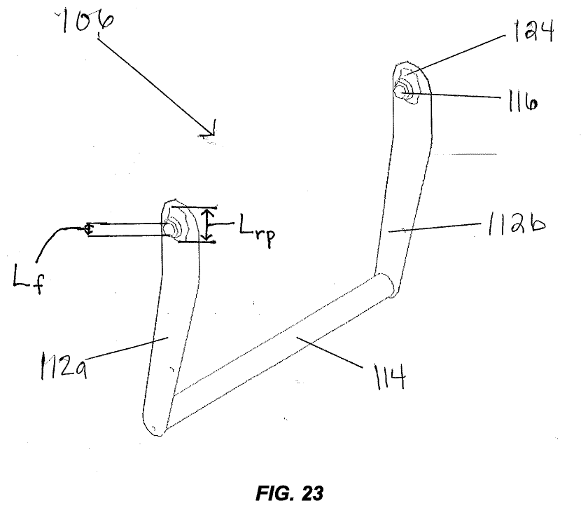

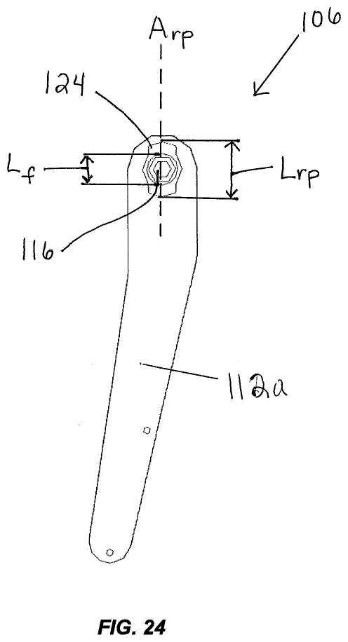

FIGS. 23 and 24 show an extended handle 106 having extension plates 112a, b, grab bar 114. Each extension plate 112a,b has a fastener 116 and a raised portion 124 through which the fastener 116 is secured. Each raised portion 124 has a length Lᵣₚ along a raised portion longitudinal axis Aᵣₚ, and each fastener has a length L_{f}. Each extension plate 112a,b may have a length of up to 18 inches.

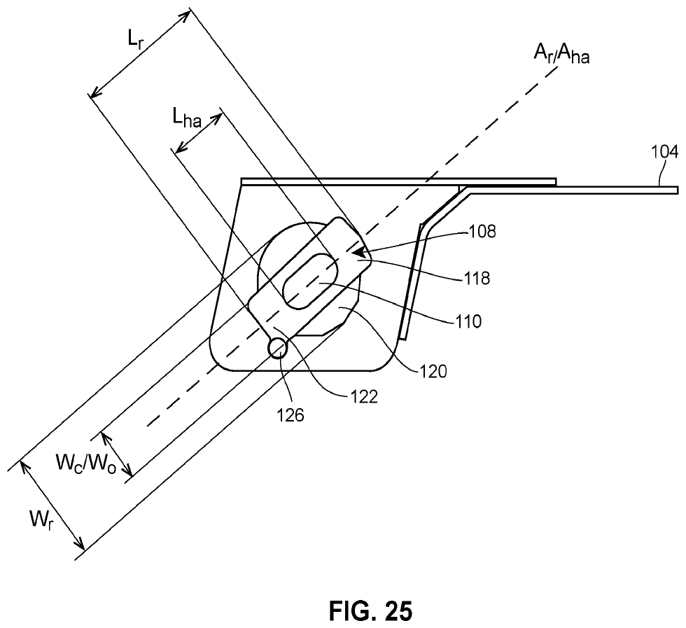

FIG. 25 illustrates a side view of a handle bracket 104. The handle bracket 104 includes a multi-position recess 108 and a handle aperture 110 within the multi-position recess. The extension plate 112a of FIG. 24 is securable by the fastener 116 to the handle aperture 110 of the handle bracket 104. The multi-position recess 108 has a recess longitudinal axis Aᵣ, and a closing portion 118, rotating portion 120, and opening portion 122 along the recess longitudinal axis Aᵣ. The extended handle 106 is positioned in an opening position when any of the raised portion 124 of the extension plate 112 of the extended handle 106 is in the opening portion 122 of the multi-position recess 108, a rotating position when all of the raised portion 124 is in the rotating portion 120 of the multi-position recess 108, and a closing position when any of the raised portion 124 is in the closing portion 122 of the multi-position recess 108.

As illustrated in FIG. 25, the multi-position recess 108 has a recess length Lᵣ along the recess longitudinal axis Aᵣ, a closing width W_{c} at the closing portion 122, a rotating width Wᵣ at the rotating portion 120, and an opening width Wₒ at the opening portion 118. The length Lᵣₚ of the raised portion 124 of the extension plate 112a is less than the recess length Lᵣ and the rotating width Wᵣ but greater than the closing width W_{c} and opening width Wₒ. In the embodiment depicted in FIG. 25, the closing portion 122 and the opening portion 118 are the same width. In embodiments not herein depicted, the closing portion 122 and the opening portion 118 may have different widths.

As further illustrated in FIG. 25, the handle aperture 110 within the multi-position recess 108 has a handle aperture length Lₕₐ along a handle aperture longitudinal axis Aₕₐ, which may be coincident with recess longitudinal axis Aᵣ. The length L_{f} of fastener 116 is less than the handle aperture length Lₕₐ such that the fastener 116 can slide within the handle aperture 110 along the handle aperture longitudinal axis Aₕₐ. The handle bracket 104 further includes a material egress hole 126 to facilitate removing debris from the multi-position recess 108.

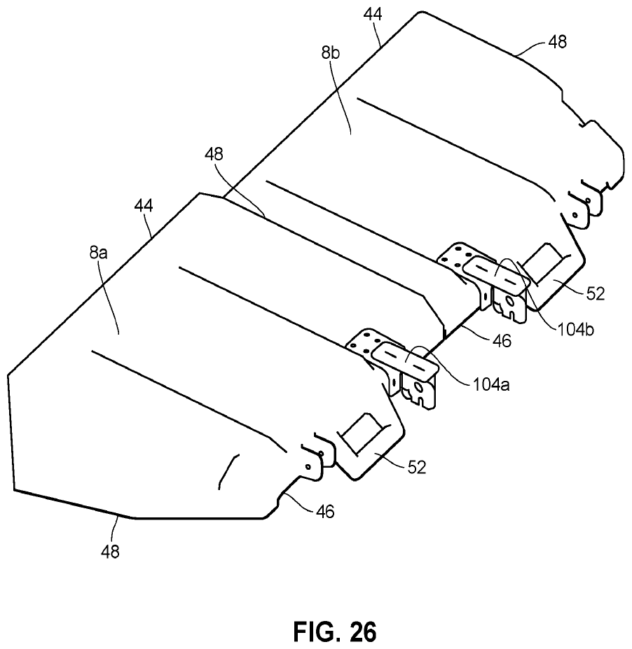

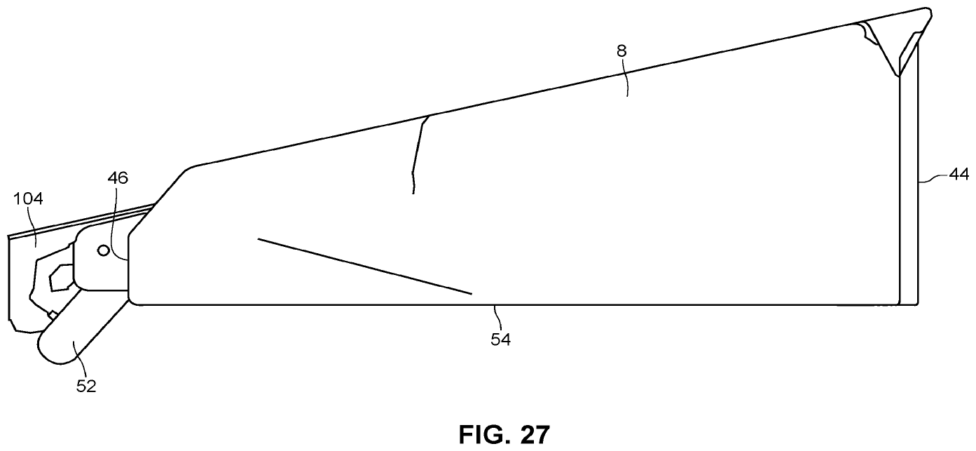

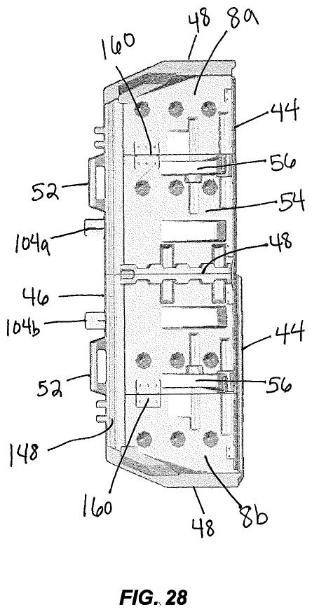

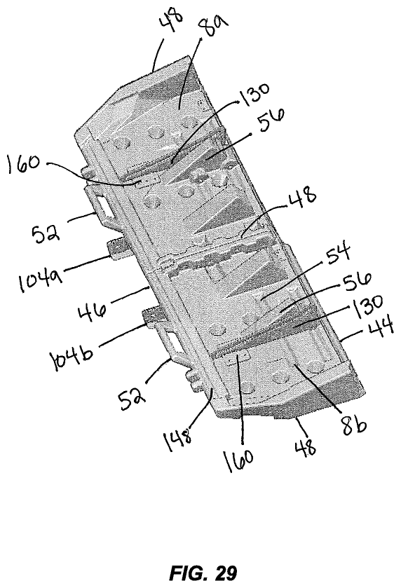

FIGS. 26-29 depict two connected modular hard covers 8 very similar to those shown in FIGS. 6-11, but configured for slide mechanisms 128 and an extended handle assembly 102. Each modular hard cover 8 includes a handle bracket 104. Each modular hard cover 8 includes a back side 44, an opening side 46, two lateral sides 48, and a bottom 54. The back side 44 of each modular hard cover 8 is opposite the opening side 46. As shown in FIGS. 28 and 29, each modular hard cover 8 includes a detent 148 configured to align with an edge of the hopper when the modular hard cover 8 is in a closed position. As best shown in FIG. 29, each modular hard cover 8 is connected to a slide plate 130 at a ridge 56 provided on the bottom 54 of each modular hard cover 8.

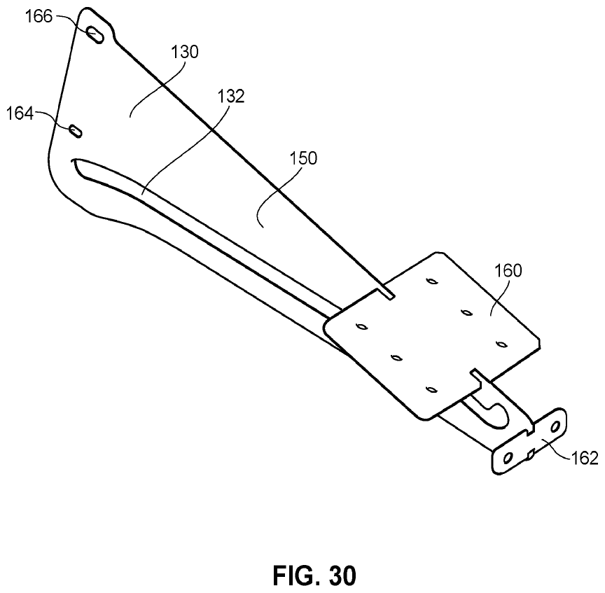

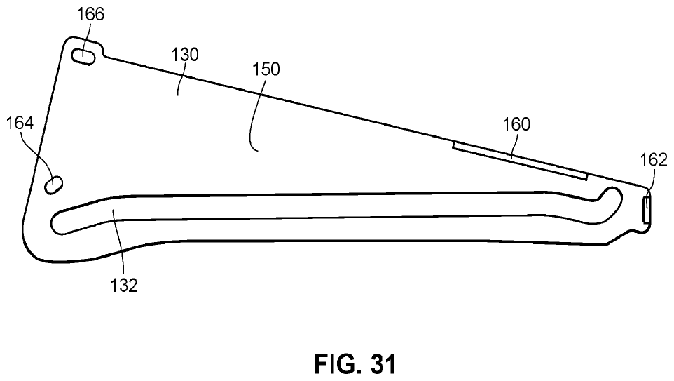

FIGS. 30 and 31 depict a slide plate 130 of a slide mechanism 128. The slide plate 130 includes a slide pathway 132. The slide plate 130 has sides 150 lateral to the slide pathway 132. The slide plate 130 includes an upper attachment plate 160 for connection to the bottom 54 of one of the one or more modular hard covers 8. The slide plate 130 further includes an opening end attachment plate 162 connected to one of the plurality of hard covers 8 near the opening side 46 of the modular hard cover 8. A first side aperture 164 and a second side aperture 166 are provided on the sides 150 of the slide plate 130 and are configured to be connected to the ridge 56 provided one the bottom 54 of each modular hard cover 8.

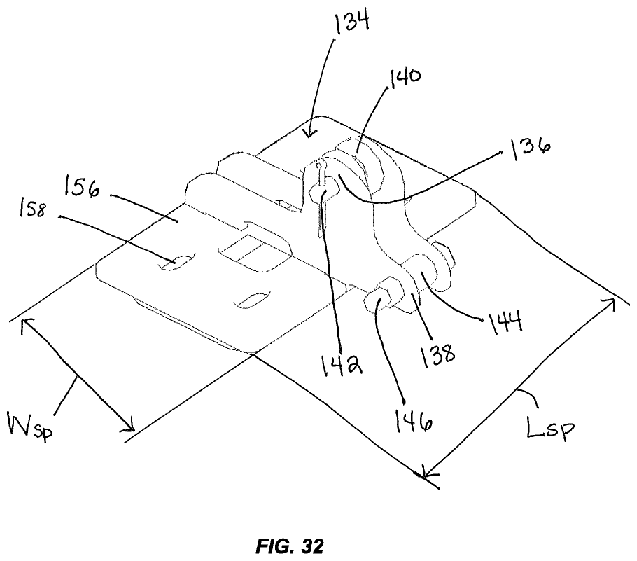

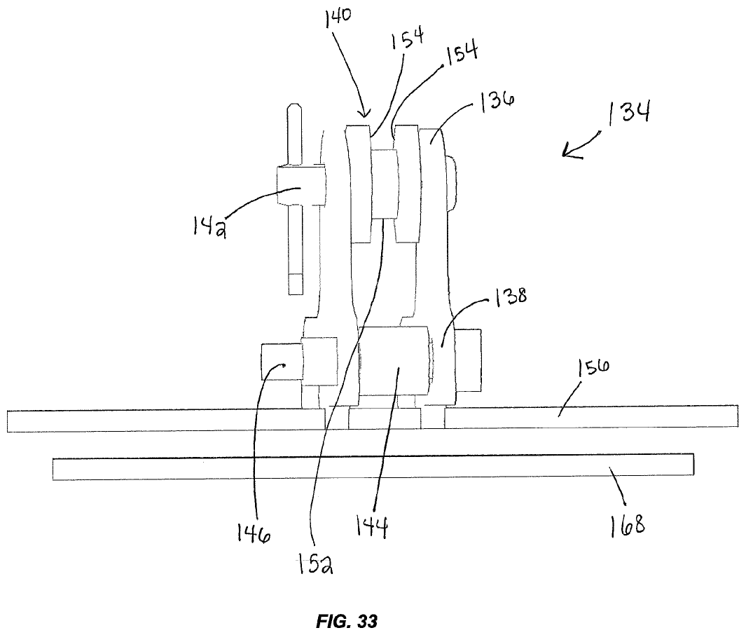

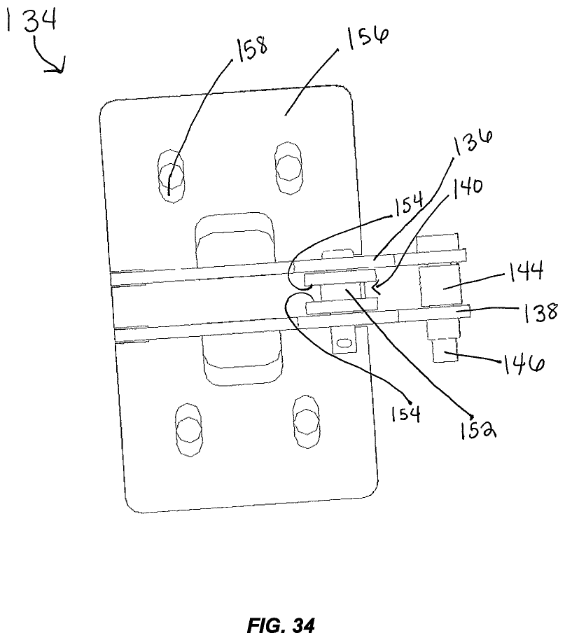

FIGS. 32-34 depict a slide mounting bracket 134 securable to a grate 14 provided on a hopper 4. The slide mounting bracket 134 includes an upper bushing 136 and a lower bushing 138. A wheel 140 is mounted on a pin 142 in the upper bushing 136. A roller 144 is mounted on a roller axle 146 in the lower bushing 138. Each of the plurality of slide mechanisms 128 is configured such that the wheel 140 is slidable in the slide pathway 132 of the slide plate 130 while the roller 144 is located below the slide plate 130. The roller 144 may include or be formed from a low friction polymer in order to facilitate movement of the slide plate 130.

The wheel 140 has a groove 152 between inner surfaces 154 of the wheel 140. The inner surfaces 154 of the wheel 140 are configured to engage the sides 150 of the slide plate 130. The slide mounting bracket 134 includes a securement plate 156. The securement plate 156 has a width Wₛₚ and a length Lₛₚ that exceed the width W_{g} and a length L_{g} of grate holes 70 of grate 14 so that the securement plate 156 can be placed atop grate 14. The slide mounting bracket 134 also includes a lower plate 168 configured for attachment below the securement plate 156 when the slide mounting bracket 134 is secured to the grate 14. Alternately, the slide mounting bracket 134 may include one or more catch plates 34 as described above with respect to the linkage mounting bracket 12.

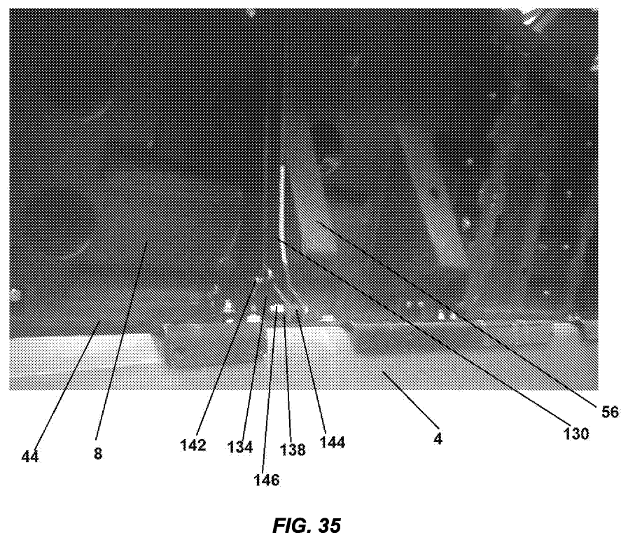

FIG. 35 shows a modular hard cover 8 positioned on its back side 44 in a service position during installation or removal of one of the plurality of slide mechanisms 128. No tools are needed to insert the wheel 140 into the slide pathway 132 of the slide plate 130 and to secure the slide mechanism with pin 142. For example, the pin 142 may be a two-part clevis pin. Further, because the modular hard cover 8 is on its back side 44, an operator does not have to hold up the weight of the modular hard cover 8 during installation or removal of a slide mechanism 128.

While various embodiments have been described herein, it will be understood that variations may be made to these embodiments that are still considered within the scope of the appended claims.

1. A spreader cover for a hopper of a spreader comprising:
one or more modular hard covers; and
an extended handle assembly;
wherein the extended handle assembly comprises a handle bracket connected to one of the one or more modular hard covers and an extended handle connected to the handle bracket;
wherein the handle bracket includes a multi-position recess and a handle aperture within the multi-position recess,
wherein the extended handle includes an extension plate and a grab bar connected to the extension plate, the extension plate securable by a fastener to the handle aperture of the handle bracket;
wherein the multi-position recess of the handle bracket has a recess longitudinal axis and a closing portion, rotating portion, and opening portion along the recess longitudinal axis;
wherein the extension plate includes a raised portion through which the fastener is secured;
wherein the extended handle is positioned in an opening position when any of the raised portion is in the opening portion of the multi-position recess, a rotating position when all of the raised portion is in the rotating portion of the multi-position recess, and a closing position when any of the raised portion is in the closing portion of the multi-position recess; and
wherein the opening portion and the closing portion of the multi-position recess are configured such that the extended handle is unable to rotate in the opening position and in the closing position.

2. The spreader cover of claim 1,
wherein the multi-position recess has a recess length along the recess longitudinal axis, a closing width at the closing portion, a rotating width at the rotating portion, and an opening width at the opening portion; and
wherein the raised portion of the extension plate has a raised portion length along a raised portion longitudinal axis that is less than the recess length and the rotating width but greater than the closing width and opening width.

3. The spreader cover of claim 1,
wherein the handle aperture within the multi-position recess has a handle aperture length along a handle aperture longitudinal axis; and
wherein the fastener of the extension plate has a fastener length that is less than the handle aperture length such that the fastener of the extension plate can slide within the handle aperture along the handle aperture longitudinal axis.

4. The spreader cover of claim 1, wherein the handle bracket further comprises a material egress hole within the multi-position recess.

5. The spreader cover of claim 1, wherein the extended handle is secured away from the hopper when in an opening or closing position, and wherein the extended handle may rotate to be secured closer to the hopper when in the rotating position.

6. The spreader cover of claim 1, wherein the extension plate has a length of up to 18 inches.

7. The spreader cover of claim 1,
wherein the extended handle assembly includes a first handle bracket and a second handle bracket, the first handle bracket secured to a first one of the one or more modular hard covers and the second handle bracket secured to a second one of the one or more modular hard covers, and
wherein the handle extension includes a first extension plate and a second extension plate, the first extension plate secured to the first handle bracket and the second extension plate secured to the second handle bracket.

8. A spreader cover for a hopper of a spreader comprising:
one or more modular hard cover;
a plurality of slide mechanisms, each slide mechanism including
a slide plate connected to one of the one or more modular hard covers, the slide plate including a slide pathway;
a slide mounting bracket connected to the hopper, the slide mounting bracket including an upper bushing and a lower bushing;
a wheel mounted on a pin in the upper bushing; and
a roller mounted on a roller axle in the lower bushing;
wherein each of the plurality of slide mechanisms is configured such that the wheel is slidable in the slide pathway of the slide plate while the roller is located below the slide plate.

9. The spreader cover of claim 8, wherein the roller comprises a low friction polymer.

10. The spreader cover of claim 8, wherein each of the one or more modular hard covers includes a detent configured to align with an edge of the hopper when the modular hard cover is in a closed position.

11. The spreader cover of claim 8,
wherein the slide plate has sides lateral to the slide pathway,
wherein the wheel has a groove between inner surfaces of the wheel, and
wherein the inner surfaces of the wheel are configured to engage the sides of the slide plate.

12. The spreader cover of claim 8,
wherein each of the one or more modular hard covers comprises a back side, an opening side, and two lateral sides, the back side being opposite the opening side, and
wherein each of the one or more modular hard covers is configured to be positioned in a service position on the back side during installation or removal of one or more of the plurality of slide mechanisms.

13. The spreader cover of claim 8,
wherein the slide mounting bracket is connected to the hopper by being secured on a grate provided on the hopper; and
wherein the slide mounting bracket includes
a securement plate having one or more fastening apertures, the securement plate having a width and a length that exceeds a width and a length of a grate hole in the grate of the hopper; and
a lower plate configured for attachment below the securement plate and the grate when the slide mounting bracket is secured to the grate.

14. The spreader cover of claim 8,
wherein each of the one or more modular hard covers has a bottom and an opening side;
wherein the slide plate includes upper attachment plate, the upper attachment plate connected to the bottom of one of the one or more modular hard covers; and
wherein the slide plate includes an opening end attachment plate, the opening end attachment plate connected to one of the one or more modular hard covers near the opening side of the modular hard cover.

15. The spreader cover of claim 8,
wherein the slide plate includes a first side aperture and a second side aperture in the sides lateral to the slide pathway;
wherein each of the one or more modular hard covers has a bottom; and
wherein a ridge is provided on the bottom of each of the one or more modular hard covers, the ridge connected to the first side aperture and the second side aperture in the sides lateral to the slide pathway.

16. A spreader cover for a hopper of a spreader comprising:
one or more modular hard covers;
a plurality of linkages, each linkage connected to one of the one or more modular hard covers, each linkage including
a linkage mounting bracket connected to the hopper;
a first link connecting the linkage mounting bracket to the one modular hard cover to which the linkage is connected;
a second link connecting the linkage mounting bracket to the one modular hard cover to which the linkage is connected; and
a retaining pin configured to secure the first link and the second link to the linkage mounting bracket.

17. The spreader cover of claim 16,
wherein the linkage mounting bracket is connected to the hopper by being secured on a grate provided on the hopper; and
wherein the linkage mounting bracket includes
a base having a first side having a first pin hole, a second side have a second pin hole aligned with the first pin hole, and a bottom plate, the bottom plate having a width and a length that exceeds a width and a length of a grate hole in the grate of the hopper;
at least one catch plate having a width that is less than the width of the grate hole, the at least one catch plate configured for attachment below the bottom plate and the grate when the linkage mounting bracket is secured to the grate;
a top having a top plate, a first inclined side, and a second inclined side, the top secured on the first side and the second side of the base; and
the retaining pin configured for insertion in the first pin hole and the second pin hole, the retaining pin configured to secure the first link between the first side of the base and the first inclined side of the top and the second link between the second side of the base and the second inclined side of the top.

18. The spreader cover of claim 16, wherein the first link is in tension when the linkage mounting bracket is connected to the hopper of the spreader, and wherein the second link is in compression when the linkage mounting bracket is connected to the hopper of the spreader.

19. The spreader cover of claim 1,
wherein each of the one or more modular hard covers comprises a back side, an opening side, and two lateral sides, the back side being opposite the opening side,
wherein the back sides of two modular hard covers of the one or more modular hard covers are adjacent to one another such that opening sides are provided on opposite sides of the hopper, and
wherein, if a lateral side of a first modular hard cover of the one or more modular hard covers is adjacent a lateral side of a second modular hard cover of the one or more modular hard covers, the adjacent lateral sides are fastened to one another.

20. The spreader cover of claim 1,
wherein each modular hard cover comprises a back side and an opening side, the back side being opposite the opening side, and
wherein each opening side includes an integral handle to facilitate opening the modular hard cover.
